(19) United States
(12) Patent Application Publication
(10) Pub. No.: US 2018/0097971 A1
(43) Pub. Date: Apr. 5, 2018

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Fumihisa SUZUKI, Kanagawa (JP)

(73) Assignee: FUJI XEROX CO., LTD., Tokyo (JP)

(21) Appl. No.: 15/719,578

(22) Filed: Sep. 29, 2017

(30) Foreign Application Priority Data
Oct. 3, 2016 (JP) 2016-195385

(51) Int. Cl. H04N 1/44; H04N 1/00

(52) U.S. Cl. CPC H04N 1/4433; H04N 1/4413; H04N 1/00411; H04N 2201/0094; H04N 1/00482

(57) ABSTRACT

An information processing apparatus includes a display that displays a screen for receiving an operation from a user, and a controller that performs control so that a screen for selecting a manager is displayed on the display in a case of detecting a condition in which a state has to transition from a first apparatus state not requiring selection of a specific manager to a second apparatus state requiring selection of the specific manager.

### CROSS-REFERENCE TO RELATED APPLICATIONS

This application is based on and claims priority under 35 USC 119 from Japanese Patent Application No. 2016-195385 filed Oct. 3, 2016.

### BACKGROUND

### Technical Field

The present invention relates to an information processing apparatus and a non-transitory computer readable medium storing a program.

### SUMMARY

According to an aspect of the invention, there is provided an information processing apparatus including a display that displays a screen for receiving an operation from a user, and a controller that performs control so that a screen for selecting a manager is displayed on the display in a case of detecting a condition in which a state has to transition from a first apparatus state not requiring selection of a specific manager to a second apparatus state requiring selection of the specific manager.

### BRIEF DESCRIPTION OF THE DRAWINGS

Exemplary embodiment(s) of the present invention will be described in detail based on the following figures, wherein:

FIG. 1 is a diagram illustrating a configuration of an image forming system including an image forming apparatus 10 according to an exemplary embodiment of the invention;

FIG. 2 is a block diagram illustrating a hardware configuration of the image forming apparatus 10 according to the exemplary embodiment of the invention;

FIG. 3 is a block diagram illustrating a functional configuration of the image forming apparatus 10 according to the exemplary embodiment of the invention;

FIG. 4 is a flow chart illustrating an operation in a case where there is an attempt to change a login system through an operation screen displayed on a terminal apparatus 20;

FIG. 5 is a diagram illustrating an example of a home screen displayed on a display of the terminal apparatus 20;

FIG. 6 is a diagram illustrating an example of an authentication and authority management screen displayed on the display of the terminal apparatus 20;

FIG. 7 is a diagram illustrating an example of a selection screen of a manager displayed on the display of the terminal apparatus 20; and

FIG. 8 is a diagram illustrating an example of a login system change screen displayed on the display of the terminal apparatus 20.

### DETAILED DESCRIPTION

Background

First, a background and an outline of the invention will be described in order to facilitate the understanding of the invention.

An image forming apparatus to be the premise of the invention is configured such that an apparatus state is set to be any one of two states of a state of an opened system and a state of a closed system.

Here, the closed system is a system in which only a user registered as a manager among plural users may change setting information. In addition, the opened system is a system in which any user of plural users may change setting information.

In a case of the state of the closed system, a user familiar with the setting or function of a device is set as a manager among plural users, and the manager collects other users' desires and the like to perform various settings such as initial setting, communication setting, and function setting of the image forming apparatus 10. The reason for the manager to perform various settings is because, in a case where the apparatus is used by as many as users such as 100 or 200, making it possible for the users to change setting information of respective apparatuses causes a concern of getting out of control.

However, in a case where an image forming apparatus is used in a small establishment of several persons to about ten persons, or the like, a specific user is selected as a manager, and only the manager may change various setting information, which leads to a bad effect of poor convenience.

That is, in a case of a small number of persons, only a user familiar with the setting or function of a device is allowed to change setting information so as not to allow other users to change setting information. For this reason, there is a great advantage in that convenience is increased rather than a possibility of a problem occurring, when all users have authority of a manager, in consideration of time and labor for selecting and registering a specific user as a manager and time and labor for changing a manager.

In addition, in the image forming apparatus, it is possible to select a login system (authentication system) used when authenticating a user, among plural login systems of a simple login system, a normal login system, a network login system, and the like.

Here, the simple login system is a system in which only the input of a user ID (user identification information) is requested, and login may be performed without inputting password information. In addition, the normal login system is a method of performing login by inputting a user ID and password information. Further, the network login system is a method in which an input user ID and password information are transmitted to an external apparatus through a network, and login is allowed on the basis of a result of collation between the user ID and the password information in the external apparatus.

In a configuration in which a state of an opened system and a state of a closed system are switchable as such a system state, a certain problem occurs in the state of the opened system and in a case where a login system is other than a simple login system, in a system configuration in which various methods may be selected as the login system.

Here, a description will be given of a problem occurring when the image forming apparatus is in a state of an opened system and a login system is other than a simple login system.

In addition, the image forming apparatus to be the premise of the invention has a function of security printing. The security printing is a function in which when a Personal Identification Number (PIN) is set in a printing job to be transmitted from a terminal apparatus 20 to an image forming apparatus, the image forming apparatus 10 allows the printing job to be output only in a case where the PIN is input.

In a case where the apparatus state of the image forming apparatus is an opened system, all users are treated as having authority of a manager. Accordingly, even when the user is an unauthenticated user or a general user, the user is treated as a user having authority of a manager. Software for controlling a security printing function is configured such that printing is allowed without inputting a PIN even in a printing job in which a PIN is set with respect to a user having authority of a manager.

However, software for controlling a security printing function is configured such that a PIN is necessarily input in order to allow printing for a printing job having a PIN set therein, in a case where a login system is a simple login system.

That is, in a case where the apparatus state of the image forming apparatus is an opened system and a login system is other than a simple login system, there is a problem in that an unauthenticated user may perform a printing job having a PIN set therein without inputting a PIN.

### Exemplary Embodiment of the Invention

Next, the exemplary embodiment of the invention will be described in detail with reference to the accompanying drawings.

The image forming apparatus 10 has the following configuration and performs the following operations.

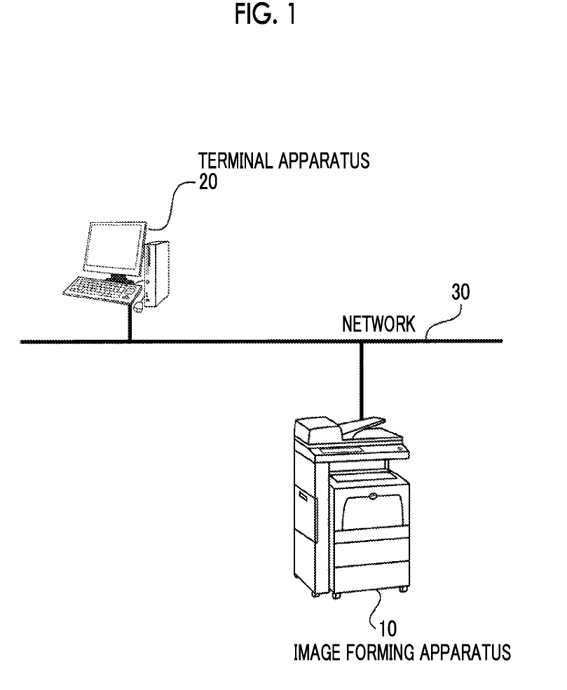

FIG. 1 is a diagram illustrating a configuration of an image forming system including the image forming apparatus 10 according to the exemplary embodiment of the invention.

The image forming system according to the exemplary embodiment of the invention is constituted by the image forming apparatus 10 and the terminal apparatus 20 which are connected to each other through a network 30 as illustrated in FIG. 1. The terminal apparatus 20 generates printing data and transmits the generated printing data to the image forming apparatus 10 through the network 30. The image forming apparatus 10 receives the printing data transmitted from the terminal apparatus 20, and outputs an image based on the printing data on a sheet. Meanwhile, the image forming apparatus 10 is an apparatus called a so-called multi-function printer having plural functions such as a print function, a scan function, a copy function, and a facsimile function.

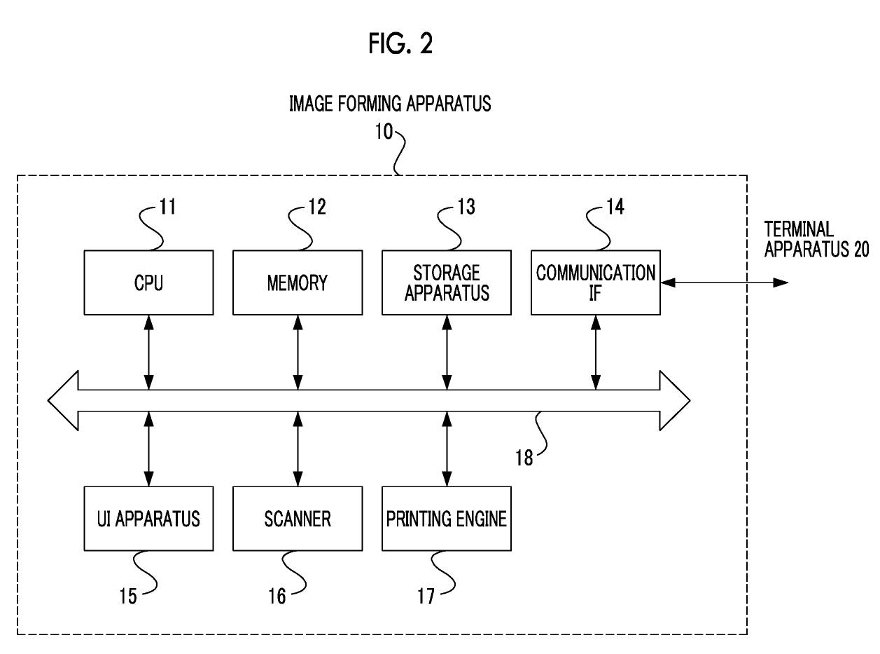

Next, a hardware configuration of the image forming apparatus 10 in the image forming system according to this exemplary embodiment is illustrated in FIG. 2.

The image forming apparatus 10 includes a CPU 11, a memory 12, a storage apparatus 13 such as a hard disk drive (HDD), a communication interface (IF) 14 transmitting and receiving data to and from an external apparatus through the network 30, a user interface (UI) apparatus 15 including a touch panel or a liquid crystal display and a keyboard, a scanner 16, and a printing engine 17, as illustrated in FIG. 2. These components are connected to each other through a control bus 18.

The printing engine 17 prints an image on a recording medium such as a printing sheet through processes such as charging, exposure, developing, transfer, and fixing.

The CPU 11 executes a predetermined process on the basis of a control program stored in the memory 12 or the storage apparatus 13 to control the operation of the image forming apparatus 10. Meanwhile, in this exemplary embodiment, a description has been given on the assumption that the CPU 11 reads out the control program stored in the memory 12 or the storage apparatus 13 and executes the control program, but the program may be stored in a storage medium such as a CD-ROM and may be provided to the CPU 11.

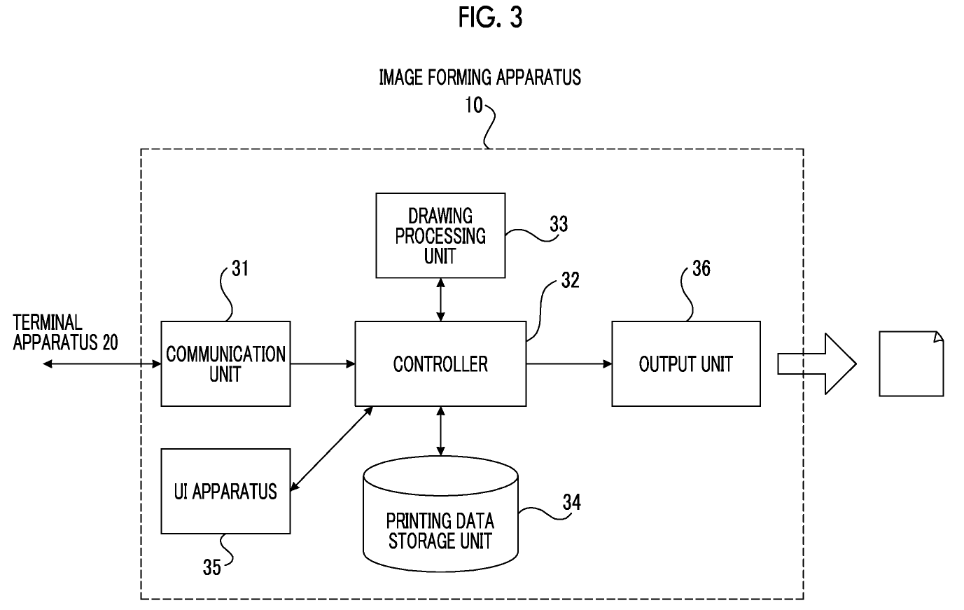

FIG. 3 is a block diagram illustrating a functional configuration of the image forming apparatus 10 which is realized by the execution of the above-described control program.

The image forming apparatus 10 according to this exemplary embodiment includes a communication unit 31, a controller 32, a drawing processing unit 33, a printing data storage unit 34, a UI apparatus 35, and an output unit 36, as illustrated in FIG. 3.

The communication unit 31 communicates with the terminal apparatus 20 to execute a process of receiving a printing job (printing instruction) transmitted from the terminal apparatus 20 or displaying a screen for confirming or changing various setting contents of the image forming apparatus 10 on the terminal apparatus 20.

That is, in the image forming apparatus 10 according to this exemplary embodiment, it is possible to confirm or change various setting contents on an operation panel of the apparatus and to confirm or change various setting contents of the image forming apparatus 10 through a screen displayed on the terminal apparatus 20.

The drawing processing unit 33 performs drawing processing on the printing job received through the communication unit 31 to convert the processed printing job into printing data in a raster format.

The UI apparatus 35 performs display processing on the user on the basis of the control of the controller 32, or receives an instruction, setting, and the like from the user.

The output unit 36 outputs an image on a recording medium such as a printing sheet on the basis of the printing data transmitted from the controller 32.

The controller 32 executes drawing processing by the drawing processing unit 33 on the printing job received by the communication unit 31 to convert the processed printing job into printing data in a raster format. The controller 32 once stores the printing data in a raster format having been subjected to the drawing processing in the printing data storage unit 34. The controller 32 transmits the printing data stored in the printing data storage unit 34 to the output unit 36 to execute printing processing.

In addition, the controller 32 transmits data to the terminal apparatus 20 through the communication unit 31 to display a screen for receiving the user's operation on the terminal apparatus 20.

In addition, the controller 32 performs control for displaying a screen for selecting a manager on the display screen of the terminal apparatus 20 in a case of detecting a condition in which a state has to transition from a state of an opened system where any user of plural users may change setting information to a state of a closed system where only a user registered as a manager among the plural users may change setting information.

Specifically, the controller 32 displays a screen for inputting password information for logging in as a manager on the display screen of the terminal apparatus 20 as a screen for specifying a manager.

In addition, the controller 32 detects a condition in which the state has to transition from the opened system to the closed system, in a case where there is an attempt to change a simple login system (simple authentication system), which allows login by only inputting a user ID (user identification information) without inputting password information, to a login system other than the simple login system in the state of the opened system.

Meanwhile, in this exemplary embodiment, a description has been given of a case where an apparatus state not requiring the selection of a specific manager is a state of an opened system, and an apparatus state requiring the selection of a specific manager is a state of a closed system, but the invention is not limited to such a case.

Next, the operation of the image forming apparatus 10 according to this exemplary embodiment will be described in detail with reference to the accompanying drawings.

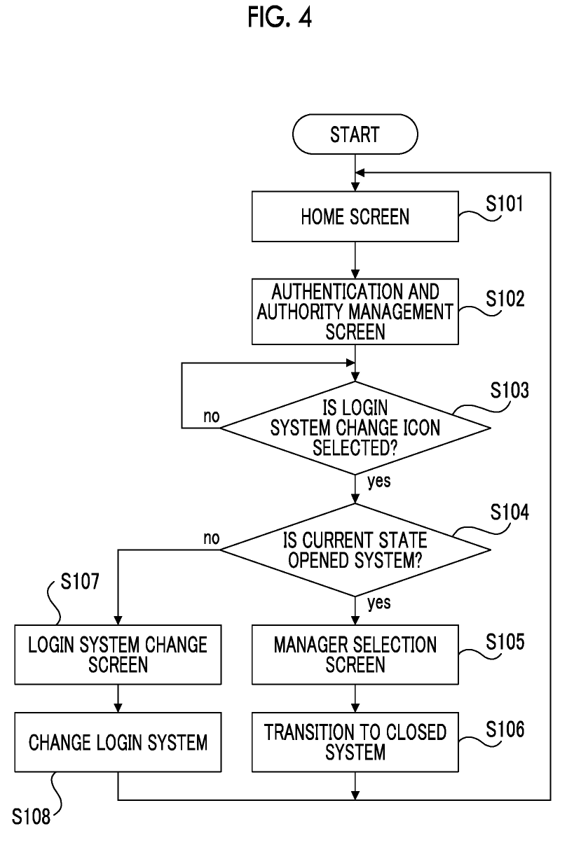

FIG. 4 is a flow chart illustrating an operation in a case where there is an attempt to change a login system through an operation screen displayed on the terminal apparatus 20.

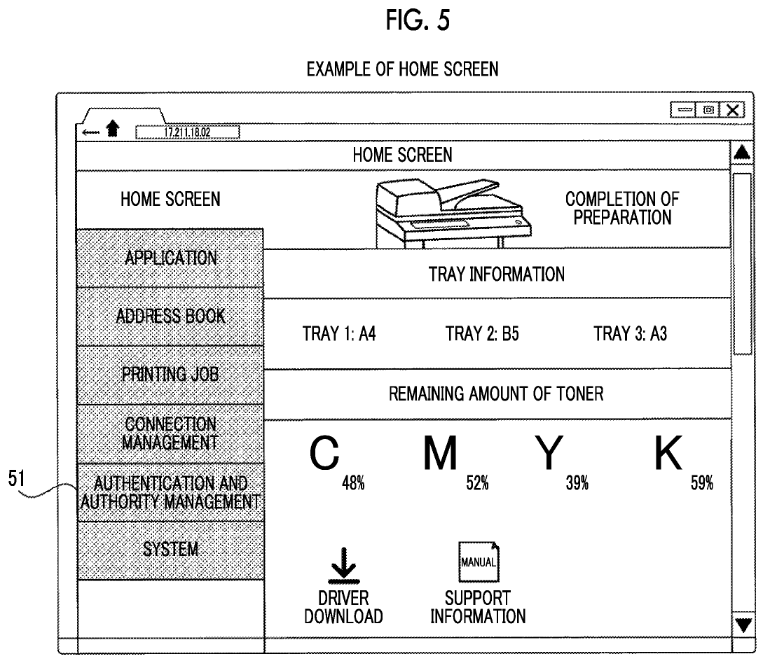

First, a home screen as illustrated in FIG. 5 is displayed on the display screen of the terminal apparatus 20 (step S101). In the home screen illustrated in FIG. 5, it is possible to confirm the current operation state of the image forming apparatus 10, tray information, toner remaining amount information, and the like.

In this home screen, a menu item for transitioning to a screen for performing various detailed setting is displayed, and transition to an authentication and authority management screen is performed by operating an authentication and authority management button 51 in the menu screen in a case where the user attempts to change a login system (step S102).

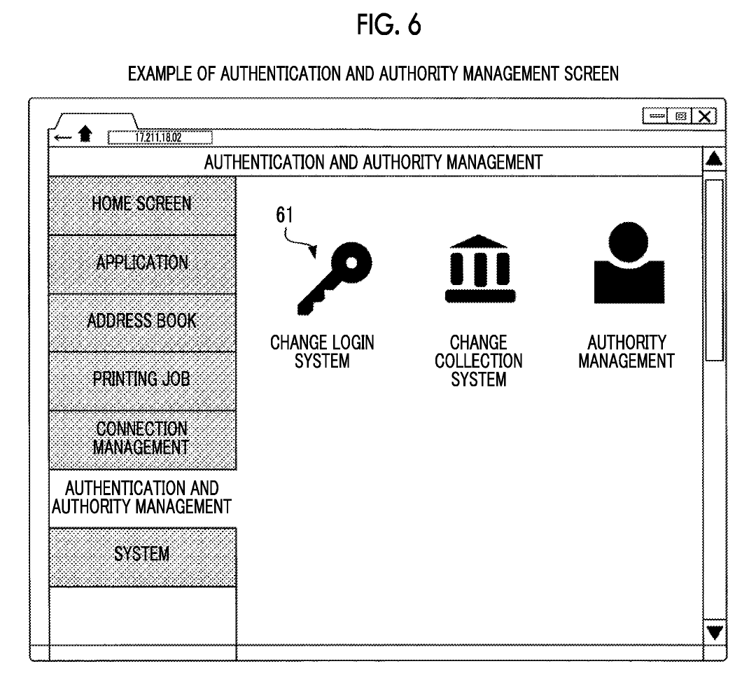

An example of the authentication and authority management screen is illustrated in FIG. 6. In the authentication and authority management screen illustrated in FIG. 6, a login system change icon 61, a collection system change icon, an authority management icon, and the like are displayed. Here, it is assumed that the login system change icon 61 is selected by the user performing an operation such as the clicking of a mouse on the login system change icon 61 (step S103).

Then, the controller 32 determines whether or not the state of the apparatus is a state of an opened system or a state of a closed system (step S104), and displays a screen varying depending on a user on the basis of the determination result.

Here, in a case where the current state of the image forming apparatus 10 is a state of an opened system (yes in step S104), the controller 32 determines that the current state is the state of the opened system and there is a possibility that a login system is a login system other than a simple login system when the login system is changed in this state, and thus the controller detects that the state has to transition from the opened system to a closed system.

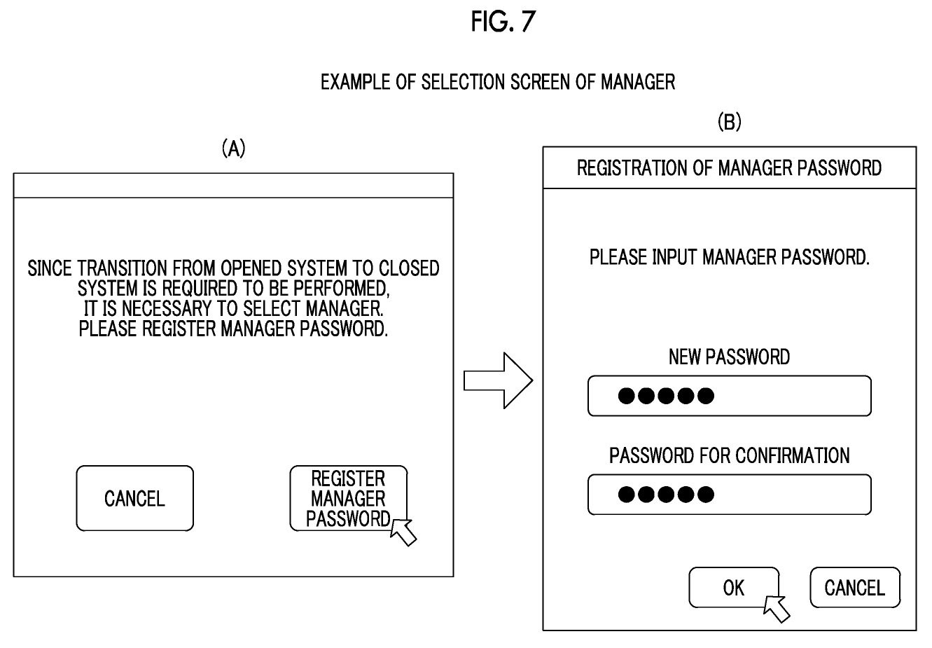

As a result, the controller 32 displays the screen as illustrated in FIG. 7 to prompt the user to select a necessary manager in order to perform transition from the opened system to the closed system (step S107).

Specifically, the controller 32 first displays the necessity of transitioning from the opened system to the closed system and the necessity of selecting a manager for the transition, to the user as illustrated in part (A) of FIG. 7. In a display screen illustrated in part (A) of FIG. 7, the user operates a button of “register manager password” to display a display screen as illustrated in part (B) of FIG. 7 and prompt the user to input a manager password.

When the user inputs the manager password and operates an OK button in the display screen illustrated in part (B) of FIG. 7, the controller 32 transitions from an opened system to a closed system (step S106). Thereafter, the controller 32 executes a process of displaying the home screen as illustrated in FIG. 5 on the terminal apparatus 20.

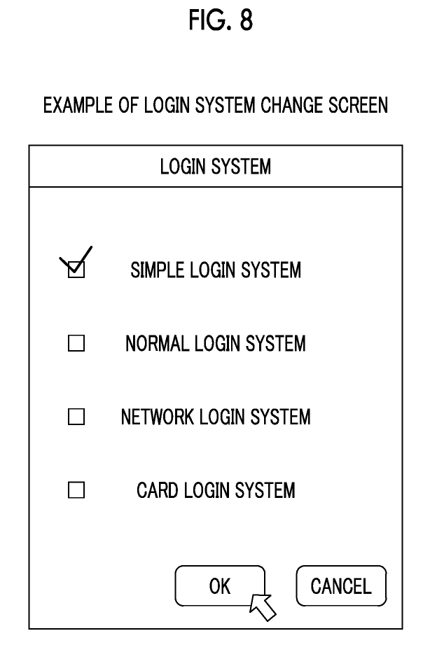

In addition, in a case where the current state of the image forming apparatus 10 is a state of a closed system in the determination process of step S104 (no in step S104), the controller 32 determines that there is no problem even when the login system is changed, and displays a login system change screen as illustrated in FIG. 8 (step S107).

When the user selects a login system in the login system change screen illustrated in FIG. 8 and operates an OK button, the controller 32 executes a process of switching to the login system selected by the user (step S108).

### MODIFICATION EXAMPLE

In the above-described exemplary embodiment, a description has been given of a case where setting values of various setting items of the image forming apparatus 10 are changed through the operation screen displayed on the display screen of the terminal apparatus 20, but the invention is not limited thereto. The invention may also be applied to a case where setting values of various setting items of the image forming apparatus 10 are changed through an operation screen displayed on an operation panel of the image forming apparatus 10.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display that displays a screen for receiving an operation from a user; and
a controller that performs control so that a screen for selecting a manager is displayed on the display in a case of detecting a condition in which a state has to transition from a first apparatus state not requiring selection of a specific manager to a second apparatus state requiring selection of the specific manager.

2. The information processing apparatus according to claim 1,
wherein the first apparatus state is a state of an opened system where any user of a plurality of users is capable of changing setting information, and the second apparatus state is a state of a closed system where only a user registered as a manager among the plurality of users is capable of changing setting information.

3. The information processing apparatus according to claim 2,
wherein the controller detects a condition in which a state has to transition from an opened system to a closed system, in a case where there is an attempt to change a simple login system, which allows login by only inputting user identification information without inputting password information, to a login system other than the simple login system, in the state of the opened system.

4. The information processing apparatus according to claim 1,
wherein a screen for specifying a manager which is to be displayed on the display by the controller is a screen for inputting password information for logging in as a manager.

5. The information processing apparatus according to claim 2,
wherein a screen for specifying a manager which is to be displayed on the display by the controller is a screen for inputting password information for logging in as a manager.

6. The information processing apparatus according to claim 3,
wherein a screen for specifying a manager which is to be displayed on the display by the controller is a screen for inputting password information for logging in as a manager.

7. A non-transitory computer readable medium storing a program causing a computer to execute:
detecting a condition in which a state has to transition from a first apparatus state not requiring selection of a specific manager to a second apparatus state requiring selection of the specific manager; and
performing control so that a screen for selecting a manager is displayed on a display in a case of detecting the condition in which the state has to transition from the first apparatus state to the second apparatus state.
